(19) United States
(12) Patent Application Publication
(10) Pub. No.: US 2021/0129316 A1
(43) Pub. Date: May 6, 2021

(54) DRIVE ASSISTING DEVICE

(71) Applicant: NIDEC COPAL CORPORATION, Tokyo (JP)

(72) Inventor: Yosuke MOMOSE, Tokyo (JP)

(73) Assignee: NIDEC COPAL CORPORATION, Tokyo (JP)

(21) Appl. No.: 16/491,848

(22) PCT Filed: Mar. 7, 2018
(86) PCT No.: PCT/JP2018/008752

§ 371 Date: Sep. 6, 2019

(30) Foreign Application Priority Data
Mar. 9, 2017 (JP) 2017-044916

(51) Int. Cl. B25J 9/10

(52) U.S. Cl. CPC B25J 9/102

(57) ABSTRACT

A drive assisting device for applying biasing forces that has the versatility to be compatible with a variety of installed states. A drive assisting device has a case from which an output shaft that is driven by an actuator protrudes; a connecting member for connecting the output shaft to that which is to be driven; an assist spring, disposed coiled around the output shaft, with one end thereof secured to the connecting member; and an adjusting member that is assembled together with the case while adjusting the biasing force of the assist spring, having the other end of the assist spring secured thereto.

### CROSS-REFERENCE TO RELATED APPLICATIONS

This application is a National Stage of International Patent Application No. PCT/JP2018/008752 filed Mar. 7, 2018 which claims priority to Japanese Application No. 2017-044916 filed Mar. 9, 2017. Both applications are herein incorporated by reference in their entirety.

### FIELD OF TECHNOLOGY

The present invention relates to a drive assisting device for assisting driving by an actuator.

### BACKGROUND

Driving devices equipped with actuators, such as servo motors, are used in joints of robotic hands, knee joints of bipedal or quadrupedal walking robots, and of motion assisting devices that supplement the movement of human joints, and the like. Such driving devices may have different required driving forces depending on the direction of rotation of the actuator. For example, with a finger joint of a robotic hand, a greater driving force is required in the gripping direction than in the opening direction, and for a knee joint of a bipedal or quadrupedal walking robot, a greater driving force is required in the direction of extension, against the force of gravity, than in the folding direction.

Conventionally, in this type of driving device, when using an actuator to drive a rotation to the right or a rotation to the left, a biasing force would be applied through a torsion coil spring or a tension coil spring in the direction of rotation to the side that requires the larger driving force, to supplement the driving force using the biasing force (referencing, example, International Patent Application Publication 2009/107164 and Japanese Unexamined Patent Application Publication 2015-66215).

With the conventional driving device described above, when used in, for example, the left and right knee joints of a bipedal walking robot, when providing driving devices symmetrically on the left and on the right, the directions of rotation to which the biasing forces are to be applied are opposite on the right side and the left side. Because of this, it has been necessary to prepare separate driving devices with different directions of application of the biasing force for the left and right in the joints. Moreover, when the driving devices are used in the left and right and front and rear knee joints of a quadrupedal walking robot, the knee bend angles that most require the assistance of biasing forces are different between the front and rear knee joints, and thus, when including the left/right differences described above, it has been necessary to prepare four different types of driving devices, with the biasing force settings different for each.

The present invention is proposed in order to handle problems such as these. Specifically, the problem is to provide a drive assisting device for applying biasing forces that has the versatility to be compatible with a variety of installed states.

### SUMMARY

In order to solve such a problem, the drive assisting device according to the present invention is equipped with the following structures:

A drive assisting device having a case from which an output shaft that is driven by an actuator protrudes; a connecting member for connecting the output shaft to that which is to be driven; an assist spring, disposed around the output shaft, with one end thereof secured to the connecting member; and an adjusting member that is assembled together with the case while adjusting the biasing force of the assist spring, having the other end of the assist spring secured thereto.

### BRIEF DESCRIPTIONS OF THE DRAWINGS

FIG. 1 is a perspective assembly diagram (viewed from above) of a drive assisting device according to an example according to the present invention.

FIG. 2 is a perspective assembly diagram (viewed from below) of a drive assisting device according to an example according to the present invention.

FIG. 3 is an assembly explanatory diagram (a perspective diagram, viewed from above) of a drive assisting device according to an example according to the present invention.

FIG. 4 is an assembly explanatory diagram (a perspective diagram, viewed from below) of a drive assisting device according to an example according to the present invention.

FIG. 5a and FIG. 5b are an overall drying of a drive assisting device to an example according to the present invention (wherein FIG. 5a is a front view and FIG. 5b is a cross-sectional view along the section A-A in FIG. 5a).

FIG. 6 is an explanatory diagram depicting a state of use of a drive assisting device according to an example according to the present invention.

### DETAILED DESCRIPTION

Examples according to the present invention will be explained below in reference to the drawings. In the descriptions below, identical reference symbols in the different drawings below indicate positions with identical functions, and redundant explanations in the various drawings are omitted as appropriate.

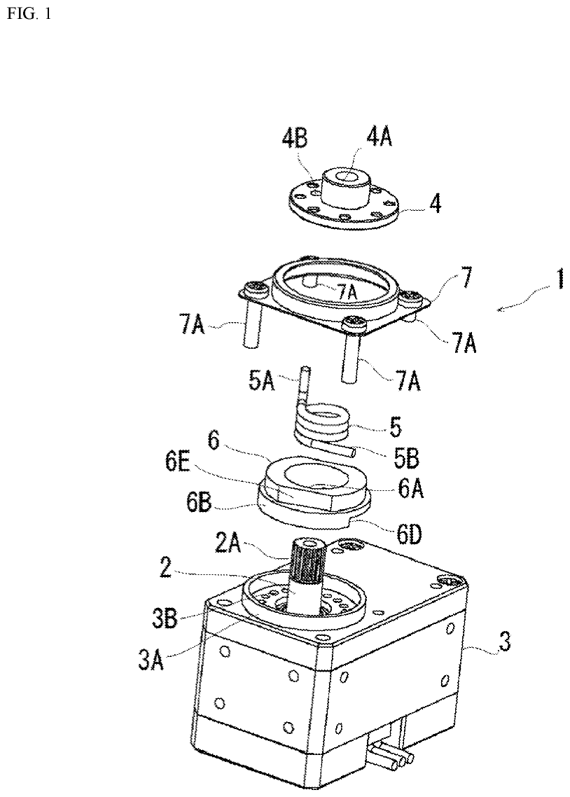

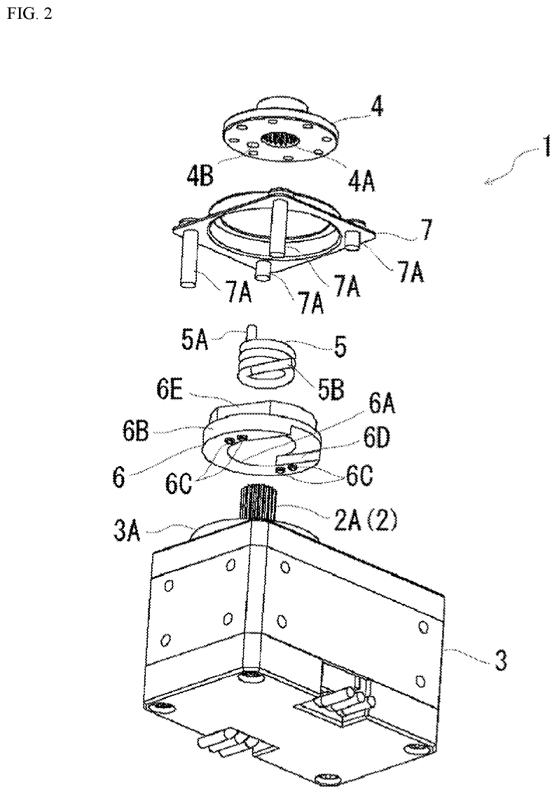

As illustrated in FIG. 1 through FIG. 5, the drive assisting device 1 comprises an output shaft 2, a case 3, a connecting member 4, an assist spring 5, an adjusting member 6, and a cover member 7.

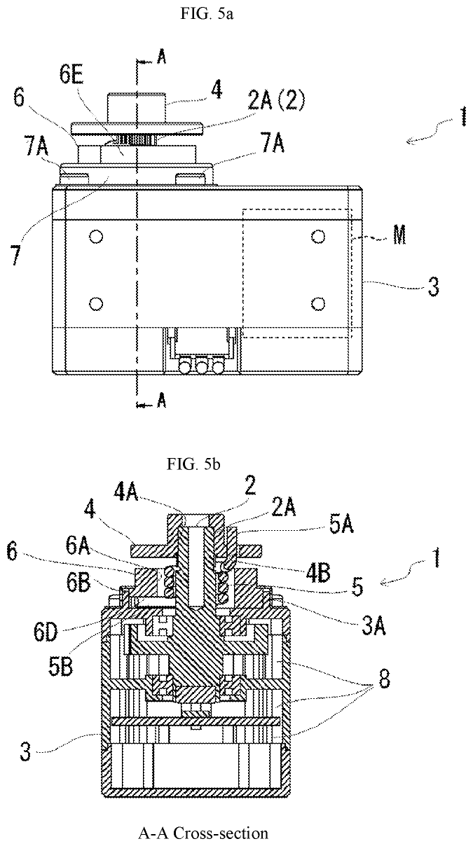

The output shaft 2 is driven rotationally by an actuator M that is disposed within, and borne by, the case 3. In the example in the figure, as illustrated in FIG. 5(b), the actuator (servo motor) M is disposed within the case 3, and the output shaft 2 is driven through a gear train 8 that is disposed within the case 3. The output shaft 2 is not limited thereto, but rather may be driven rotationally by an actuator that is disposed outside of the case 3.

The case 3 is equipped with a cylindrical adjusting member storing portion 3A for containing the adjusting member 6, around the output shaft 2. A plurality of positioning holes 3B is disposed around the output shaft 2 within the adjusting member storing portion 3A.

A mating portion 2A is formed at the tip end portion of the output shaft 2, where the mating portions 2A engages with a mated portion 4A of the connecting member 4, so that the connecting member 4 will be driven rotationally together with the output shaft 2. The connecting member 4 is a member (horn) for connecting the output shaft 2 that is to be driven. The connecting member 4 is for provided, in the center thereof, with the aforementioned mated portion 4A, and is provided with a plurality of engaging holes 4B therearound.

The assist spring 5 is a torsion coil spring that is disposed so as to be coiled around the output shaft 2, where one end portion 5A extends in the same direction as the output shaft 2, and engages with one of the engaging holes 4B of the connecting member 4. The other end portion 5B of the assist spring 5 extends in a direction that is perpendicular to the output shaft 2, and engages with the adjusting member 6.

The adjusting member 6 is provided with a center hole portion 6A through which the output shaft 2 and the assist spring 5 pass, where the outer peripheral edge 6B, which is of a circular column shape, is contained within the adjusting member storing portion 3A of the case 3, so as to be supported so as to be able to rotate around the output shaft 2 onto which the assist spring 5 is coiled. Additionally, the adjusting member 6 is provided with a mating protrusion 6C on the back face side thereof, where this mating protrusion 6C is positioned securely, in respect to the case 3, through engaging with a positioning hole 3B that is provided within the adjusting member storing portion 3A of the case 3.

An engaging groove portion 6D that communicates with the center hole portion 6A is formed on the back face side of the adjusting member 6, where the other end portion 5B of the assist spring 5 engages with this engaging groove portion 6D. Furthermore, the adjusting member 6 is provided with gripping surfaces 6E on the outer peripheral surface thereof, to enable adjustment through rotating the adjusting member 6 around the output shaft 2 through gripping the gripping surfaces 6E with a tool, such as a wrench.

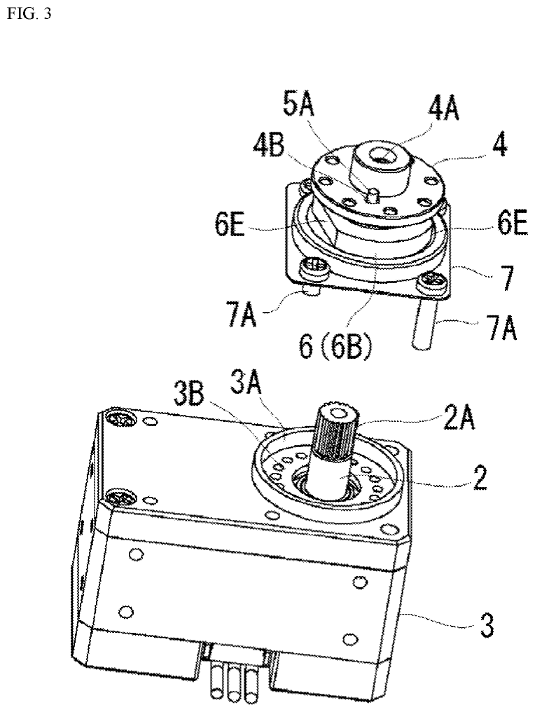

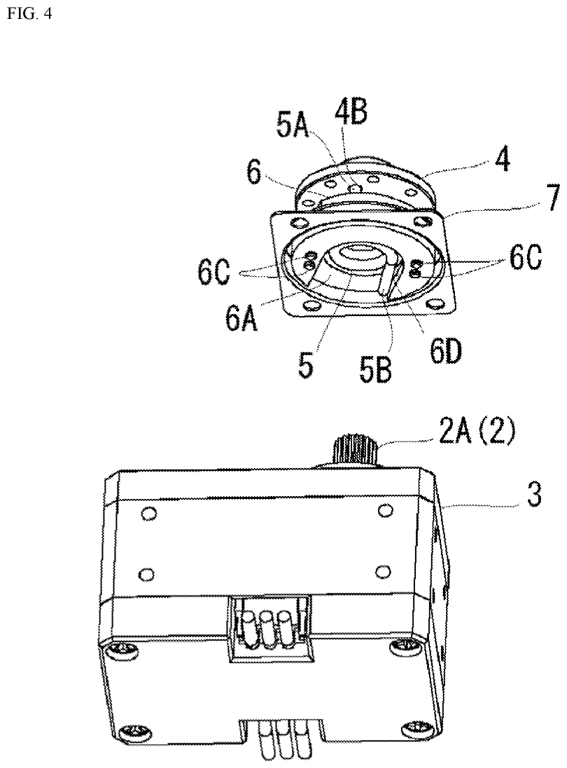

When assembling the drive assisting device 1, the assist spring 5 is placed within the center hole portion 6A of the adjusting member 6, the connecting member 4 is placed over the adjusting member 6, the one end portion 5A of the assist spring 5 is engaged with the engaging hole 4B of the connecting member 4, and the other end portion 5B of the assist spring 5 is engaged with the engaging groove portion 6D that is in communication with the center hole portion 6A of the adjusting member 6, as illustrated in FIG. 3 and FIG. 4. In this state, the cover member 7 is placed covering the outer peripheral edge 6B of the adjusting member 6, and, with the mated portion 4A of the connecting member 4 engaged with the mating portion 2A of the output shaft 2, the mating protrusion 6C of the adjusting member 6 is positioned in a positioning hole 3B of the case 3, and the cover member 7 is attached to the case 3 through a screw 7A.

At the time of this assembly, the adjusting member 6 is held in a state wherein the gripping surfaces 6E are gripped by a wrench, or the like, and at the stage that the connecting member 4 is engaged with the output shaft 2, the adjusting member 6 is rotated, as appropriate, around the output shaft 2, to adjust the torsional biasing force of the assist spring 5, and then engaged to the case 3 in the arbitrarily adjusted state, to secure the position thereof.

Such a drive assisting device 1 enables assisting the driving force of the output shaft 2, which is driven rotationally by the actuator M, through the torsional biasing force of the assist spring 5 in only one direction. At this time, the biasing force of the assist spring 5 is applied constantly to the output shaft 2, making it possible to prevent backlash of the output shaft 2 that is driven through the gear train 8.

Additionally, through adjusting the adjusting member 6 rotationally at the time of assembly, the biasing force of the assist spring 5 can be adjusted to an arbitrary state. The adjustment of the biasing force by the adjusting member 6 enables even the biasing direction to be adjusted. Moreover, the opposite assistance direction can be produced easily, through changing the assist spring 5 to a spring with the opposite coiling direction. In this way, the drive assisting device 1 according to the example according to the present invention enables a single drive assisting device 1 to be applied to a variety of sites with different assist forces and assist directions. This enables the provision of a drive assisting device with the versatility that enables compatibility with a variety of installation conditions.

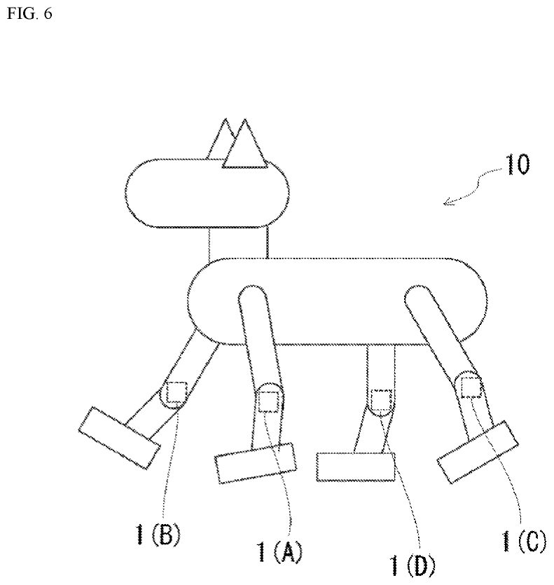

FIG. 6 depicts an example of the application of the drive assisting device 1 according to the example according to the present invention to knee joints of a quadrupedal walking robot 10. Assisting the four actuators that are used in the knee joints of a quadrupedal walking robot 10 requires the use of drive assisting devices 1 (A) and 1 (B), which have mutually differing assist directions on the left and the right on the forefront side, and requires the use of drive assisting devices 1 (C) and 1 (D), which have mutually opposite left/right assist directions, with the assist forces set to be different from those on the forefoot side. For such an installed scenario, it is possible to handle the four drive assisting devices 1 (A), 1 (B), 1 (C), and 1 (D) with a single device, by merely adjusting the biasing forces of the assist springs 5 through the adjusting members 6, and having the coiling directions of the assist springs 5 be different on the left and the right. This makes it possible to provide a drive assisting device with a broad range of applicability.

While examples according to the present invention were described in detail above, referencing the drawings, the specific structures thereof are not limited to these examples, but rather design variations within a range that does not deviate from the spirit and intent of the present invention are also included in the present invention. Moreover, insofar as there are no particular contradictions or problems in purposes or structures, or the like, the technologies of the various examples described above may be used together in combination.

1. A drive assisting device comprising:
a case from which an output shaft that is driven by an actuator protrudes;
a connecting member connecting the output shaft to that which is to be driven;
an assist spring, disposed around the output shaft, with one end thereof secured to the connecting member; and
an adjusting member that is assembled together with the case while adjusting the biasing force of the assist spring, having the other end of the assist spring secured thereto.

2. The drive assisting device as set forth in claim 1, wherein:
the assist spring is a torsion coil spring that is disposed so as to be coiled around the output shaft; and
the adjusting member adjusts a biasing force of the assist spring through rotation around the output shaft, and engages with the case in an arbitrarily adjusted state.

3. The drive assisting device as set forth in claim 1, wherein the output shaft is driven through a gear train that is provided within the case.
